(19) United States
(12) Patent Application Publication
(10) Pub. No.: US 2011/0004129 A1
(43) Pub. Date: Jan. 6, 2011

(54) TEETH TRAINING TOOL

(76) Inventor: Torvald Wavle, Malmo (SE)

Correspondence Address: BROOKS KUSHMAN P.C., 1000 TOWN CENTER, TWENTY-SECOND FLOOR, SOUTHFIELD, MI, 48075, US

(21) Appl. No.: 12/865,660

(22) PCT Filed: Jan. 31, 2008
(86) PCT No.: PCT/SE08/00090

§ 371 Date: Jul. 30, 2010

(51) Int. Cl. A61H 1/00

(52) U.S. Cl. 601/38

(57) ABSTRACT

A device for training the teeth, comprising a tooth rubber of hard rubber provided with a surface intended for bearing against the teeth. The tooth rubber may comprise slide prevention means in the nature of ridges and/or grooves. Alternatively, the tooth rubber is provided with a central portion and a side portion intended to bear against the chewing surfaces of the teeth, during use, and a side portion intended to be positioned, during use, adjacent the side surfaces of the teeth and extend towards or up to the gingiva. Two tooth rubbers may be connected to a link intended to extend, during use, from one side of the jaw to the other.

### AREA OF INVENTION

The present invention relates to a training tool for teeth training and more specifically to a tool for training the premolar and molar teeth (grinder) as well as the jaw muscles.

### BACKGROUND ART

One of today's endemic diseases is periodontitis, loosening of teeth. For several years, the inventor of the present invention has worked with these problems and found that regular training of the teeth is advantageous, i.a. for preventing periodontitis and for increasing the blood circulation.

Chewing gum is an effective means for training the jaw muscles. However, the chewing gum is too elastic for having any effect on periodontitis.

Instead, the inventor has developed a training method in which a tooth rubber of a hard rubber material is used for training the teeth. Without being bound by a specific theory for how the training is advantageous for preventing periodontitis, it is supposed that the hard tooth rubber results in that the connective tissue which retains the teeth to the tooth bone has to work in the manner it was originally intended to work and therefore operates better. Such training results in a better teeth status, which can influence upon the incidence of dental caries.

### SUMMARY OF THE INVENTION

The inventor has worked on and unexpectedly found that periodontitis can be further prevented or at least reduced by tissue promoting exercise of the teeth by a tooth rubber with a substantial hardness and wherein the tooth rubber is maintained at place in an efficient manner.

Thus, an object of the present invention is to mitigate the above mentioned problems and provide a training tool for training of teeth.

According to an aspect of the invention, there is provided a device for training teeth, comprising a tooth rubber provided with a surface intended to bear against said teeth, wherein the tooth rubber comprises slide prevention means in the nature of ridges and/or grooves on said surface. The ridges and/or grooves may extend in the transversal direction of the tooth rubber. Alternatively or in addition, the ridges and/or grooves may extend in the longitudinal direction of the tooth rubber.

In an embodiment, the tooth rubber substantially may have the shape of a parallelepipedon. The tooth rubber may also be sustantially in the shape of a hexagonal, circular or oval.

In another embodiment, the ridges and/or grooves may be arranged on at least two surfaces of said tooth rubber, such as on three or four surfaces thereof.

In a further embodiment, the tooth rubber may comprise: a central portion intended to bear, during use, against the chewing surfaces of the teeth, and a side portion intended to be positioned, during use, adjacent the side surfaces of the teeth and extend towards or up to the gingiva. Furthermore, the tooth rubber may comprise a second side portion positioned opposite to the first-mentioned side portion and intended to be positioned, during use, adjacent the second side surfaces of the teeth and extend towards or up to the gingiva. A first tooth rubber may be connected to one end of a link intended to extend, during use, from one side of a jaw to the other side, and a second tooth rubber may be connected to the other end of the link.

The tooth rubber may be made in a single piece by hard rubber.

### BRIEF DESCRIPTION OF THE DRAWINGS

Further objects, features and advantages of the invention will become apparent from the detailed description given below of embodiments of the invention with reference to the appended drawings, in which:

FIG. 1 is a perspective view of an embodiment of the invention.

FIGS. 2 to 9 are a perspective view of further embodiments of the invention.

FIG. 10 is a perspective view of an alternative embodiment of the invention.

FIG. 11 is a side view of the embodiment according to FIG. 10.

FIG. 12 is a side view of a further embodiment of the invention.

FIGS. 13 to 15 are perspective views over alternative embodiments in relation to the embodiment of FIG. 10.

FIG. 16 is a cross-sectional view of an embodiment similar to FIG. 12, but with a double-sided tooth rubber.

FIG. 17 is a perspective view of an embodiment provided with double directed slide preventing means.

FIG. 18 is a perspective view of an embodiment similar to FIG. 15, but with a somewhat different design.

FIG. 19 is a perspective view of an embodiment with double directed slide preventing means.

FIG. 20 is a side view of the embodiment of FIG. 19.

### DETAILED DESCRIPTION OF EMBODIMENTS

Below, several embodiments of the invention will be described with references to the drawings. These embodiments are described in illustrating purpose in order to enable a skilled person to carry out the invention and to disclose the best mode. However, such embodiments do not limit the invention. Moreover, other combinations of the different features are possible within the scope of the invention.

According to a prior art method, a tooth rubber was used in the shape of a parallelepipedon with plane parallel surfaces. The tooth rubber had a size of about 33*12*8 mm. The size was such that the tooth rubber bears against about 3 teeth simultaneously in both jaws in order to efficiently train the teeth and the connective tissue retaining the teeth to the jaw bone.

However, the teeth exercising effect of the prior art tooth rubber can be improved by providing the surface intended to bear against the teeth with a slide prevention means. In this way, it is possible to chew harder without risking sliding, which results in a safer chewing training. The user also feels himself more secure due to the minimized risk of sliding.

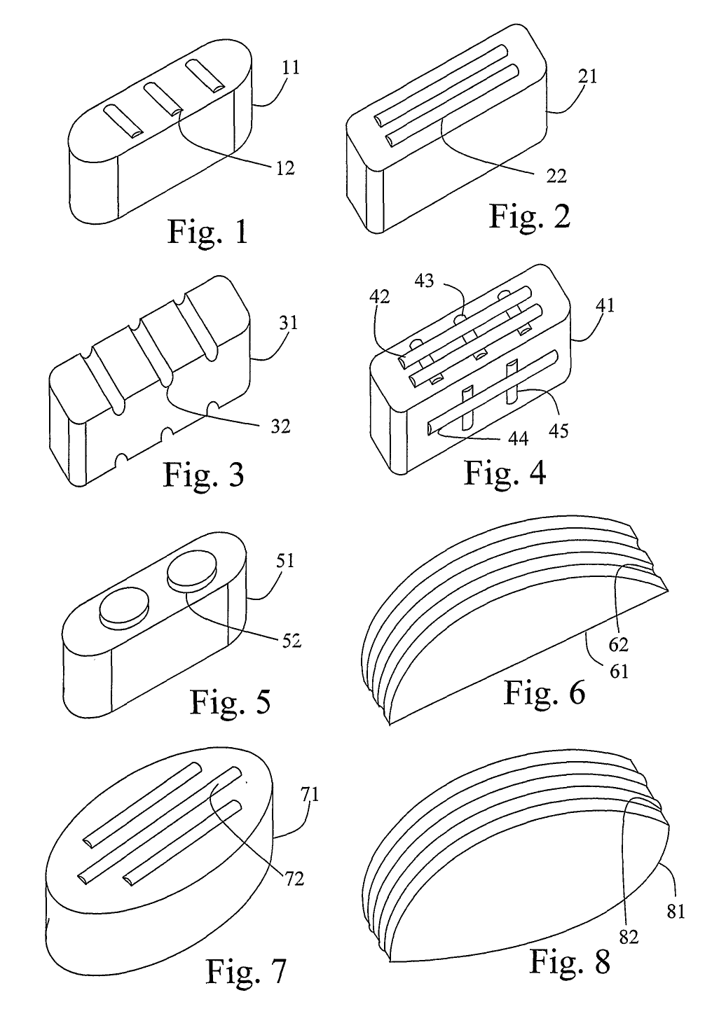

FIG. 1 shows an embodiment in which the tooth rubber 11 comprises three transversal ridges 12. Each ridge extends over slightly more than half the width of the tooth rubber 11 and can have a width of about 1 mm and a length of about 4 mm. The tooth rubber may have a width of about 6 mm, a height of about 6 mm and a length of about 30 mm. The ridges prevent or reduce the risk that the tooth rubber, during use, can slide in the longitudinal direction along the teeth.

FIG. 2 shows another embodiment, in which the ridges 22 of the tooth rubber 21 extend in the longitudinal direction. FIG. 2 shows two ridges on the upper side, but any suitable number of ridges can be used, such as 2 to 4 ridges. The longitudinal ridges prevent the tooth rubber from sliding in the transversal direction.

FIG. 3 shows an alternative embodiment, in which the ridges in the embodiment of FIG. 1 are replaced by grooves 31 arranged at both the upper and the lower surface and possibly the side surfaces. The grooves extend over the entire width of the tooth rubber 31, but may be shorter.

The ridges 11 and 21 and the grooves 31 may be arranged at both the upper and the lower surface, or at just one surface, or at three or four sides thereof. The tooth rubber may comprise both ridges and grooves in any combination.

The upper and lower surfaces are the surfaces, which are intended to bear against the teeth of the jaw during use.

FIG. 4 shows another embodiment of the tooth rubber similar to the embodiment of FIG. 2. The tooth rubber 41 comprises two longitudinal ridges 42, and three transversal ridges 43 on the top surface. Moreover, the tooth rubber comprises a longitudinal ridge 44 and two transversal ridges 45 at the side surface. The bottom surface and the other side surface may comprise the same arrangement of ridges. The ridges are all of the same height.

FIG. 5 shows another embodiment of the tooth rubber 51, wherein the slide prevention means is in the form of cylindrical elevations 52, similar to Lego® blocks. In addition to operate as slide prevention means, the elevations 52 also operate to separately load the teeth which contact the elevations, which results in extra training of such teeth.

FIG. 6 shows a further embodiment of a tooth rubber 61 in which the upper surface is arched and provided with longitudinal ridges 62. The lower surface is essentially plane and can be provided with ridges or grooves, or can be entirely flat.

FIG. 7 shows an embodiment of a tooth rubber 71 provided with ridges 72 at its upper and possibly at its lower surfaces. The tooth rubber 71 is oval or circular as seen from above and has a substantially even thickness.

FIG. 8 shows an embodiment of a tooth rubber 81, in which the upper and possibly the lower surfaces are provided with longitudinal ridges 82. The tooth rubber 81 is essentially shaped as an almond.

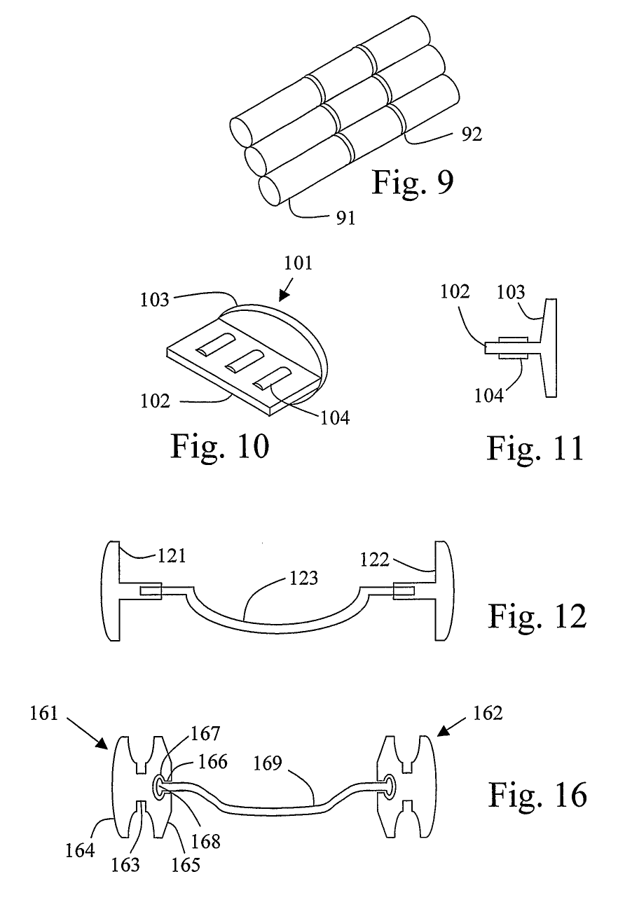

FIG. 9 shows an embodiment of a tooth rubber 91 comprising three interconnected cylindrical rods, each provided with ridges 92.

As appears from the above embodiments, the tooth rubber can have different shapes, such as parallelepipedon-shape, but with more or less rounded edges, round or oval shapes, hexagon shape or almond shape. Further shapes are conceivable, see further below.

FIG. 10 is an alternative embodiment of a tooth rubber. A tooth rubber 101 is shaped in a single piece with a central portion 102 with a parallelepipedon shape and a side portion 103 extending essentially perpendicular in relation to the central portion. Ridges 104 extend in the transversal direction.

FIG. 11 shows the tooth rubber 101 in a side view. The central portion is similar to the embodiments shown in FIGS. 1 to 9 and can be provided with slide prevention means, not shown. The side portion 103 operates as a protection for the inside of the cheek so that the cheek does not risk being jammed or hurt. In addition, the side portion 103 also operates for massaging the gingiva close to the tooth in order to increase the blood flow. Teeth pockets are influenced upon. This embodiment of the tooth rubber can advantageously be used for all teeth, both front teeth and molars.

FIG. 12 shows and embodiment in which two tooth rubbers 121 and 122 are connected to each other with a transversal link 123, which is intended to be placed below the tongue during use. This embodiment is particularly suitable for training the molars. The tooth rubbers 121, 122 can be rigidly connected to the link, for example by glue or an adhesive. Alternatively, the tooth rubbers may be rotateable in relation to the link, around the axis of the link. This embodiment makes easier the training of the molars, which may be performed with a grinding, partly rotating movement.

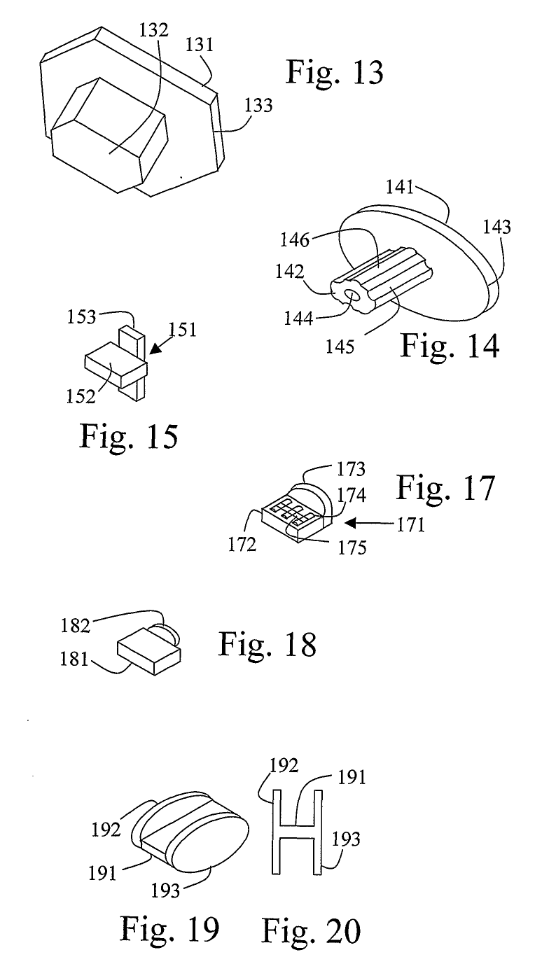

Such grinding, partly rotating movement can also be trained with the tooth rubbers appearing from FIGS. 13 and 14. The tooth rubber 131 according to FIG. 13 comprises a central portion 132 with essentially hexagonal cross-sectional area, which can be partly rounded. The central portion is attached to the side portion, which can be hexagonal, possibly with rounded corners. The tooth rubber 131 can be used separately or connected to a link. The hexagonal central portion 132 can be provided with slide prevention means according to any of the embodiments shown in FIGS. 1 to 9.

FIG. 14 shows a tooth rubber with a circular or oval cross-sectional area. The tooth rubber 141 may have a central portion, which is cylindrical or oval in cross-section and comprises a hole 144 for engagement with a link 123 according to FIG. 12. The hole is sufficiently large so that the tooth rubber is able to rotate in relation to the link 123 around an axis parallel with the hole 144. The central portion comprises transversal grooves 145 and transversal ridges 146 arranged with a groove followed by a ridge and so on.

The central portion can have a diameter of 4 to 15 mm, such as 5 to 10 mm, for example 6 to 8 mm. Moreover, the tooth rubber 141 has a side portion 143 intended to bear, during use, against the outside of the tooth and towards the inside of the cheek. Then, the side portion 143 will massage the gingiva at the root of the tooth and also influence upon possible tooth pockets so that they are counteracted. By the rotational movement, the side portion 143 will more efficiently massage the tooth gingiva.

FIG. 15 shows a further embodiment of the tooth rubber 151. The tooth rubber comprises an essentially parallelepipedic central portion 152 and a parallelepipedic side portion 153, which is glued to the central portion 152. The operation is the same as in previous embodiments.

FIG. 16 shows an embodiment similar to the one shown in FIG. 12. In the embodiment according to FIG. 16, the central portion 163 of the tooth rubber 161 is surrounded by two symmetrical side portions 164 and 165. Each side portion is shaped so that it corresponds to the shape of the tooth side and the tooth gingiva at the root of the tooth. One of the side portions is also provided with a hole 166 with an inner portion 167 with enlarged diameter. The hole encloses the shaft of a link 169. The outer end of the shaft is provided with a shoulder 168 with increased diameter, which fits into the inner portion of the hole 167. In this way, the tooth rubber can be pushed on to the shaft and be snapped to the shaft, since the tooth rubber is somewhat flexible or elastic. The tooth rubber is retained on the link 169 during normal conditions and is rotateable on the link. The central portion 163 can have a circular or oval cross-sectional area, or be oblong, similar to the embodiment according to FIG. 10.

At cleaning, the device is disassembled so that the tooth rubbers are removed and cleaned separately and the link is cleaned separately. Possibly, new tooth rubbers may then be mounted on the link or else the cleaned tooth rubbers are reused. If the user wants to use tooth rubbers of a different type, the tooth rubbers are replaceable.

FIG. 17 shows a further alternative embodiment in which the central portion 172 of the tooth rubber 171 is provided with both transversal and longitudinal ridges 174, 175. In the figure, three transversal ridges 174 and one longitudinal ridge 175 are shown, but any suitable number of ridges or grooves may be used. Moreover, the tooth rubber 171 is provided with a side portion 173, which extends merely upwards in the figure and is oval. The lower side of the tooth rubber is completely flat.

FIG. 18 shows an embodiment, which similar to FIG. 15 comprises two interconnected portions, one of which is oval 182 and one of which is a parallelepipedon 181. The portion 181 may be provided with slide prevention means as shown above.

FIG. 19 is a perspective view of an embodiment with double side portions 192, 193, which are oval and surround the central portion 191.

FIG. 20 is a side view of the embodiment of FIG. 19.

The side portion may be narrowing towards the periphery in a manner shown in FIG. 11. In this case, the side of the side portion facing the tooth is chamfered in order to be adapted to the shape of the tooth. Alternatively or in combination, the side portion may be chamfered on the outer side, as appears from FIG. 12. The side portion may have a peripheral surface, which is essentially flat but with a small extension, possibly less than 1 mm in the axial direction.

The tooth rubber can be made integrally in a single piece, as shown in FIG. 11. Alternatively, the tooth rubber may be composed of several portions, which are interconnected in a suitable manner, for example by gluing, adhesive, welding, vulcanization etc, see for example FIG. 15.

The tooth rubber can be used for training all teeth, the front teeth, the pre-molar teeth and the molar teeth.

The tooth rubber can provide advantages such as reduced risk for loosing teeth and reduced risk for dental caries. Moreover, the tooth rubber may be used for reducing the problem of teeth gnashing during sleep. The embodiments of the tooth rubber being provided with a side portion has the advantage that they cannot be swallowed or enter the pharynx, since they are too large. Thus, they can be used during sleep without any risk.

The tooth rubber can be manufactured in a version for adult and in a smaller version for children.

A suitable length for the tooth rubber is about 30 to 35 mm. Then, the tooth rubber has a length corresponding to 3 teeth. It can also be shorter and correspond to a single tooth or two teeth. A suitable length is then about 20 mm or 10 mm. The height should be as indicated above. The width should be sufficiently large so that the teeth are loaded in the entirety thereof and do not slide off the tooth rubber. A width corresponding to the double tooth width is useable. Such a width can be about 8 to 16 mm. In the embodiment of FIG. 16, the width should correspond to a tooth width of the molars. Thus, a suitable width may be about 10 mm.

The ridges and the grooves are shown to be parallel with one of the side surfaces of the tooth rubber, but they can alternatively extend with an angle to these side surfaces, for example 45 or 30 degrees. The ridges or the grooves can be shaped to form a trademark, for example the letter W, or a message, for example L for left and R for right.

The link 123 or 163 may be elastic.

The invention has been illustrated above by several embodiments, which do not limit the invention. The different properties shown in the different figures and embodiments can be combined in other manners than those shown. The invention is only limited by the appended patent claims.

1. A device for training teeth, comprising a tooth rubber provided with a surface intended to bear against said teeth, wherein said tooth rubber comprises slide prevention means in the nature of ridges and/or grooves on said surface.

2. The device according to claim 1, wherein said ridges and/or grooves extend in the transversal direction of the tooth rubber.

3. The device according to claim 1, wherein said ridges and/or grooves extend in the longitudinal direction of the tooth rubber.

4. The device according to claim 1, wherein said tooth rubber substantially has the shape of a parallelepipedon.

5. The device according to claim 1, wherein said tooth rubber sustantially has a hexagonal, circular or oval shape.

6. The device according to claim 1, wherein said ridges and/or grooves are arranged on at least two surfaces of said tooth rubber, such as on three or four surfaces thereof.

7. The device according to claim 1, wherein said tooth rubber comprises:
a central portion intended to bear, during use, against the chewing surfaces of the teeth, and
a side portion intended to be positioned, during use, adjacent the side surfaces of the teeth and extend towards or up to the gingiva.

8. The device according to claim 7, wherein said tooth rubber comprises a second side portion positioned opposite to the first-mentioned side portion and intended to be positioned, during use, adjacent the second side surfaces of the teeth and extend towards or up to the gingiva.

9. The device according to claim 7, wherein a first tooth rubber is connected to one end of a link intended to extend, during use, from one side of a jaw to the other side, and a second tooth rubber is connected to the other end of the link.

10. The device according to claim 1, wherein said tooth rubber is made in a single piece by hard rubber.
